(19) United States
(12) Patent Application Publication
(10) Pub. No.: US 2026/0090537 A1
(43) Pub. Date: Apr. 2, 2026

(54) TURKEY TOTER

(71) Applicant: Gregory C. Dye, Saltillo, MS (US)

(72) Inventor: Gregory C. Dye, Saltillo, MS (US)

(21) Appl. No.: 19/233,766

(22) Filed: Jun. 10, 2025

Related U.S. Application Data
(60) Provisional application No. 63/632,119, filed on Apr. 10, 2024.

(51) Int. Cl. A01M 31/00; A45F 3/14

(52) U.S. Cl. CPC A01M 31/006; A45F 3/14; A45F 2003/142

(57) ABSTRACT

A hunting accessory for carrying a harvested wild game animal includes a material having a conically-shaped top edge which extends downwardly and outwardly to a bottom edge, an elongated strap member secured to the material to form two carrying handles, and a plurality of hook and loop fasteners for securing the harvested wild game animal within the material, forming a carrier. The material may be positioned with a harvested animal on its underside, with the animal's neck near the top edge and feet toward the bottom edge. The material's edges may be folded over the animal and secured with the hook and loop fasteners, creating a protective carrier with convenient carrying handles. In a preferred embodiment, the hunting accessory is specifically designed for carrying wild turkeys, providing protection during transport and preventing damage to the harvested animal.

### CROSS-REFERENCE TO RELATED APPLICATIONS

This application claims priority to and the benefit of U.S. Provisional Patent Application No. 63/632,119, filed on Apr. 10, 2024, entitled “Turkey Toter,” which is hereby incorporated by reference in its entirety.

### FIELD OF THE INVENTION

The present disclosure relates generally to hunting accessories. More particularly, the present disclosure relates to a hunting accessory for carrying or toting small wild game animals such as birds and especially turkeys.

### BACKGROUND

After harvesting wild game such as turkeys, hunters often face the challenge of transporting the animal from the hunting location to their vehicle. Traditional methods include dragging the animal or carrying it unprotected over the shoulder by grabbing its legs, which can damage the harvested animal and be physically taxing for the hunter.

Various game carriers exist in the prior art, but many are cumbersome, difficult to pack, or fail to adequately protect the harvested animal during transport. Accordingly, there remains a need for an improved carrier specifically designed for transporting small wild game animals such as turkeys.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In various embodiments, a hunting accessory for carrying small wild game animals is provided. The hunting accessory may include a material having a top conically-shaped edge extending downwardly and outwardly to a bottom flared edge, an elongated strap member forming carrying handles, and fastening members for securing the harvested animal within the material to form a carrier.

In one embodiment, the hunting accessory may be particularly adapted for carrying wild turkeys, providing a protective carrier that prevents damage to the harvested animal during transport from the hunting location.

To accomplish the foregoing and related ends, certain illustrative aspects are described herein in connection with the following description and the annexed drawings. These aspects are indicative of the various ways in which the principles disclosed herein may be practiced, all of which are intended to be within the scope of this disclosure. Other advantages and novel features may become apparent from the following detailed description when considered in conjunction with the drawings.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a top perspective view of a turkey tote according to an embodiment of the present disclosure.

FIG. 2A is a bottom perspective view of the turkey tote according to an embodiment of the present disclosure.

FIG. 2B is a bottom perspective view of the turkey tote having a harvested turkey disposed thereon according to an embodiment of the present disclosure.

FIG. 3 is a side perspective view of the turkey tote showing hook and loop fasteners according to an embodiment of the present disclosure.

FIG. 4 is a side perspective view showing the turkey tote with the hook and loop fasteners engaged according to an embodiment of the present disclosure.

### DETAILED DESCRIPTION

In the following detailed description, numerous specific details are set forth to provide a thorough understanding of the embodiments disclosed herein. However, it will be understood by those skilled in the art that the principles disclosed herein may be practiced without these specific details. In some instances, well-known methods, procedures, components, and circuits have not been described in detail so as not to obscure the embodiments disclosed herein. It is to be understood that the embodiments described herein may be used as a basis for designing or modifying other structures for carrying out the same purposes of the present disclosure. It should also be recognized that the embodiments described herein may be implemented in various forms including hardware, software, firmware, or combinations thereof.

The present disclosure is directed to a hunting accessory and particularly to a hunting carrier for toting a wild turkey. While the hunting accessory may be referred to herein as a “turkey tote,” it should be understood that the subject matter described in this specification and set forth in the appended claims may be utilized for carrying or toting any small wild game animal, and is not limited to turkeys.

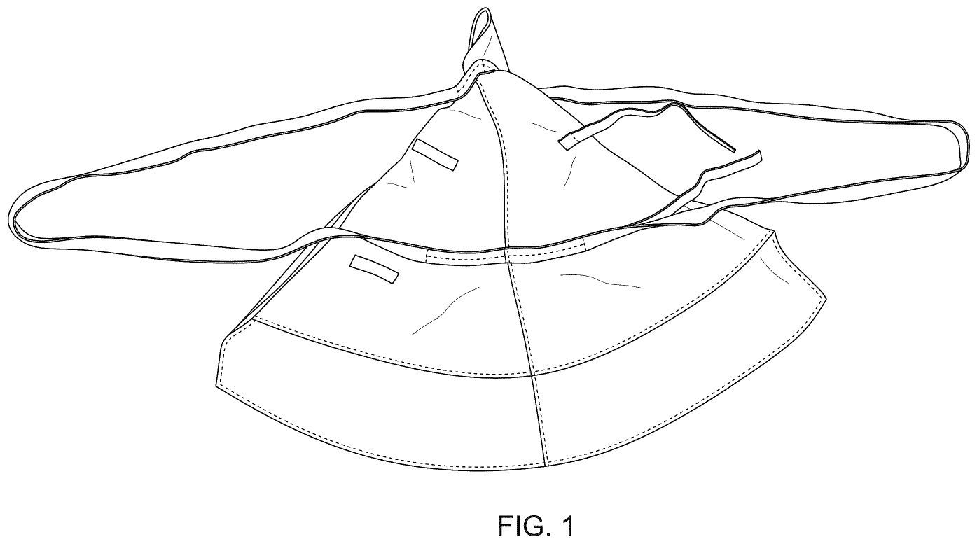

Referring now to FIG. 1, a turkey tote 100 according to an embodiment of the present disclosure is illustrated. The turkey tote 100 may comprise a material 102 having an outer side 104 with a top conically-shaped edge 106 which extends downwardly and outwardly to a bottom flared edge 108. The material 102 may also include a right edge 110 and a left edge 112.

The turkey tote 100 may further include a one-piece elongated strap member 114 having a first end 116, a second end 118, and a midpoint 120 positioned halfway between the first end 116 and the second end 118. The elongated strap member 114 may be attached to the outer side 104 of the material 102 at its midpoint 120 at about the center of the outer side 104 of the material 102. The first end 116 of the elongated strap member 114 may be attached to the outer side 104 of the material 102 at a first point near the top conically-shaped edge 106, and the second end 118 of the strap member 114 may be attached to the outer side 104 of the material 102 at a second point near the top conically-shaped edge 106. This arrangement of the one-piece strap member 114 forms two carrying handles 122, 124.

The outer side 104 of the material 102 may further comprise a plurality of hook and loop fasteners, such as Velcro-type fasteners. In the embodiment shown in FIG. 1, a first hook and loop fastener 126 may be attached to the outer side 104 of the material 102 near the top conically-shaped edge 106. A second hook and loop fastener 128 may be attached to the outer side 104 of the material 102 distally from the first hook and loop fastener 126, at about the midpoint of the outer side 104 of the material 102. A third hook and loop fastener 130 may be attached to the outer side 104 of the material 102 between the first hook and loop fastener 126 and the second hook and loop fastener 128.

The material 102 may be formed from any suitable flexible material, including but not limited to canvas, nylon, polyester, cotton, or other natural or synthetic fabrics. The material 102 may be water-resistant or waterproof in some embodiments. The elongated strap member 114 may be formed from the same material as the material 102, or may be formed from a different material providing suitable strength for carrying a harvested animal.

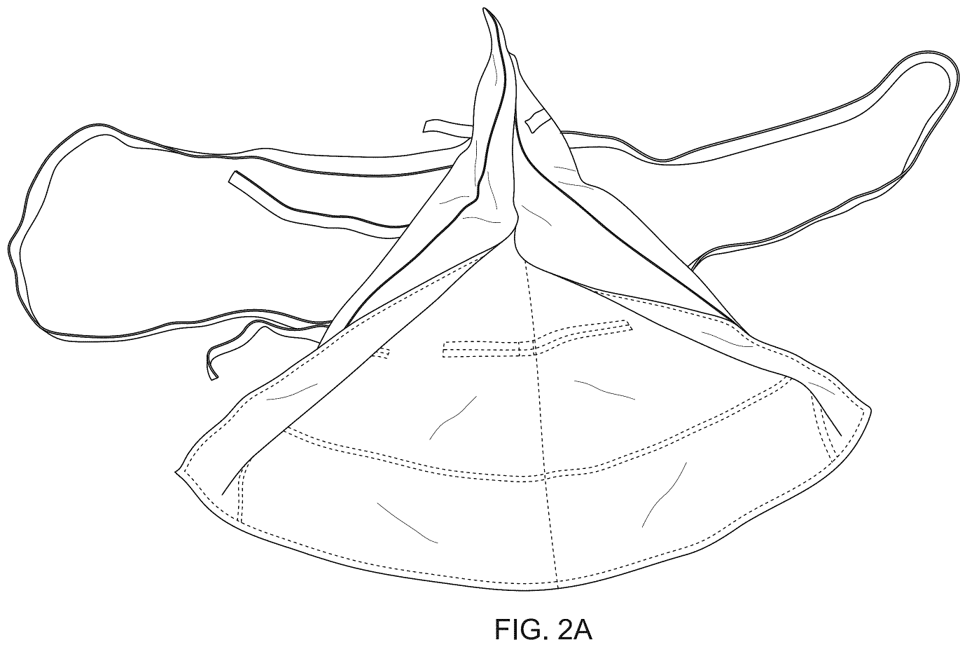

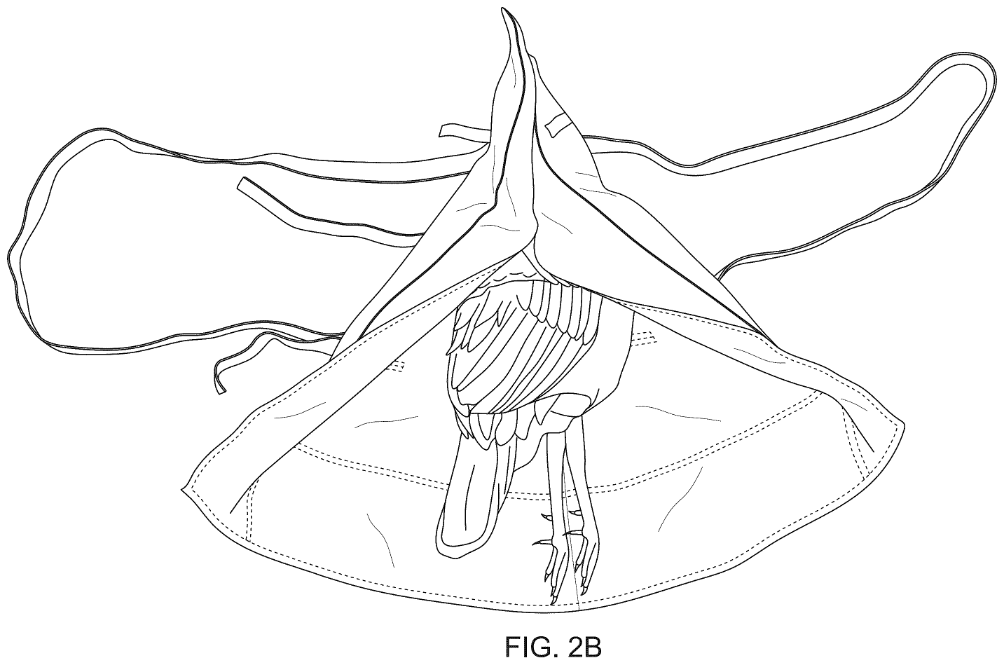

FIG. 2A shows the turkey tote 100 from a bottom perspective view, illustrating an underside 132 of the material 102. As shown, a portion of the material 102 at the top conically-shaped edge 106 may be folded over. The underside 132 may have a smooth surface to prevent damage to the feathers or other features of a harvested animal.

Referring to FIG. 2B, the operation of the turkey tote 100 is illustrated. A harvested wild turkey 134 may be placed atop the underside 132 of the material 102 in such a manner that the turkey's neck 136 is positioned near the top conically-shaped edge 106 and the turkey's feet 138 extend downwardly toward the bottom flared edge 108. The conical shape of the material 102, with its narrower top edge 106 and wider bottom edge 108, may be particularly suited to accommodate the natural shape of a turkey or similar game bird.

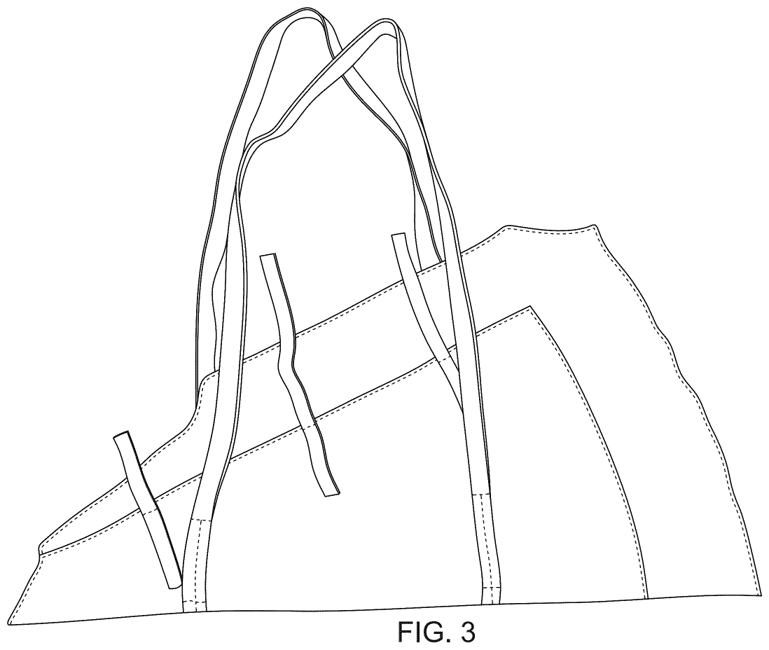

As illustrated in FIG. 3, once the turkey 134 is positioned atop the underside 132 of the material 102, the right edge 110 of the material 102 may be folded over the body of the turkey 134, and then the left edge 112 may be folded over the right edge 110. This folding creates a carrier for the turkey 134 with the carrying handles 122, 124 extending therefrom. The hook and loop fasteners 126, 128, 130 may be positioned to secure the folded edges of the material 102.

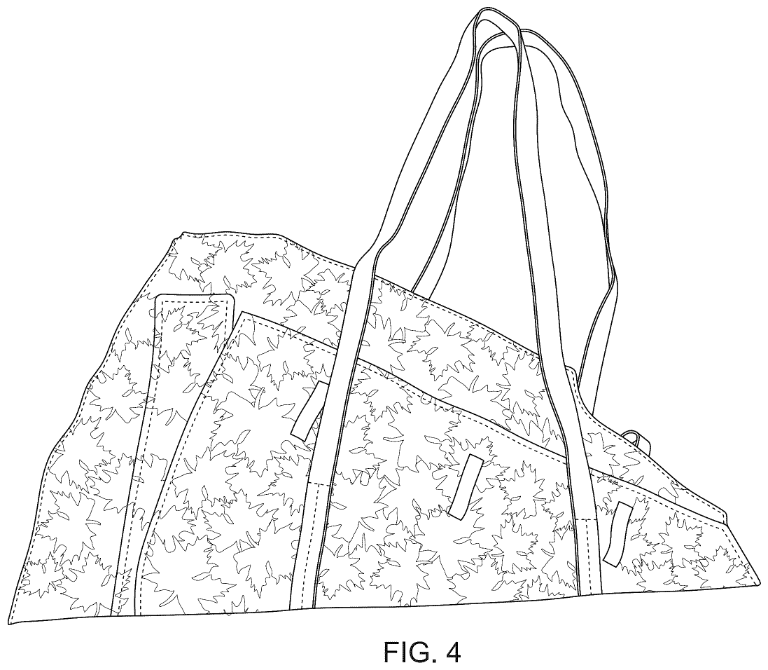

As shown in FIG. 4, the hook and loop fasteners 126, 128, 130 may be engaged to tighten the material 102 about the body of the wild turkey 134, thereby securing the wild turkey 134 within the carrier. Each hook and loop fastener 126, 128, 130 may include a hook portion and a loop portion that engage with one another when pressed together, allowing for adjustable tightening around the harvested animal.

When properly secured, the turkey tote 100 completely encloses the harvested turkey 134, protecting it from damage during transport. The carrying handles 122, 124 provide a comfortable means for the hunter to carry the harvested turkey without having to drag it or carry it by its legs.

The turkey tote 100 may be easily folded or rolled when not in use, making it convenient to pack and carry while hunting. The simple design allows for quick deployment when needed after harvesting an animal.

While the embodiments described herein and illustrated in the figures depict a turkey tote with three hook and loop fasteners, it should be understood that other embodiments may include more or fewer fasteners. Similarly, while a one-piece elongated strap member forming two carrying handles is described, other embodiments may include alternative handle configurations, such as separate handles attached at different locations on the material.

The turkey tote may be manufactured in various sizes to accommodate different sizes of game animals. For example, a smaller version may be suitable for smaller game birds, while a larger version may be used for larger turkeys or other game animals.

The embodiments disclosed herein provide several advantages over conventional methods of transporting harvested game animals. The turkey tote protects the harvested animal from damage during transport, provides a comfortable and convenient carrying method for the hunter, and can be easily packed and carried while hunting.

While several illustrative embodiments have been shown and described, numerous variations and alternative embodiments will occur to those skilled in the art. Such variations and alternative embodiments are contemplated and may be made without departing from the scope of the disclosure as defined in the appended claims.

What is claimed is:

1. A hunting accessory for carrying a small wild game animal comprising:
a. a material having a top conically-shaped edge, a bottom edge extending downwardly and outwardly from said top conically-shaped edge, a right edge, a left edge, a center line between said right edge and said left edge, an upper side, and an underside;
b. an elongated strap member having a first end, a second end and a midpoint, said first end and said second end each being attached to said upper side of said material near said top conically-shaped edge, and said midpoint being attached to said upper side of said material at a point midway between said top conically-shaped edge and said bottom edge and along said center line in such a manner that said elongated strap member forms two carrying handles; and
c. a plurality of hook and loop fasteners attached to said upper side of said material,
wherein, when a wild game animal is disposed on the underside of said material with its neck disposed near the top conically-shaped edge and its feet extending downward towards said bottom edge and wherein said right edge and left edge are folded tightly over the wild game animal and said plurality of hook and loop fasteners are secured to one another, the material is converted into a carrier for toting the wild game animal.

2. The hunting accessory for carrying a small wild game animal according to claim 1, wherein said plurality of hook and loop fasteners is three hook and loop fasteners.

3. The hunting accessory for carrying a small wild game animal according to claim 2, wherein each of said plurality of hook and loop fasteners has a first end in the form of a hook attachment means and a second end in the form of a loop attachment means, said first end and said second end engaging one another to form a fastening means.

4. The hunting accessory for carrying a small wild game animal according to claim 3, wherein a first hook and loop fastener is attached near the top conically-shaped edge, a second hook and loop fastener is attached near said point midway between said top conically-shaped edge and said bottom edge, and a third hook and loop fastener is attached between said first hook and loop fastener and said second hook and loop fastener.

5. The hunting accessory for carrying a small wild game animal according to claim 1, wherein said material is formed from a flexible fabric.

6. The hunting accessory for carrying a small wild game animal according to claim 5, wherein said flexible fabric is selected from the group consisting of canvas, nylon, polyester, and cotton.

7. The hunting accessory for carrying a small wild game animal according to claim 1, wherein said small wild game animal is a turkey.

8. The hunting accessory for carrying a small wild game animal according to claim 1, wherein said elongated strap member is formed from the same material as said material.

9. The hunting accessory for carrying a small wild game animal according to claim 1, wherein said material is water-resistant.

10. The hunting accessory for carrying a small wild game animal according to claim 1, wherein said top conically-shaped edge has a width that is narrower than a width of said bottom edge.

11. A method of carrying a harvested wild game animal, comprising:
a. providing a carrier comprising a material having a top conically-shaped edge, a bottom edge extending downwardly and outwardly from said top conically-shaped edge, a right edge, a left edge, an upper side, and an underside, an elongated strap member forming two carrying handles, and a plurality of hook and loop fasteners;
b. placing the harvested wild game animal on the underside of the material with the animal's neck positioned near the top conically-shaped edge and the animal's feet extending toward the bottom edge;
c. folding the right edge of the material over the harvested wild game animal;
d. folding the left edge of the material over the right edge; and
e. securing the plurality of hook and loop fasteners to enclose the harvested wild game animal within the carrier.

12. The method according to claim 11, wherein the harvested wild game animal is a turkey.

13. The method according to claim 11, wherein said plurality of hook and loop fasteners is three hook and loop fasteners.

14. The method according to claim 11, further comprising carrying the harvested wild game animal using the two carrying handles formed by the elongated strap member.

15. A hunting carrier for toting a wild turkey, comprising:
a. a flexible material having a conically-shaped configuration with a top edge narrower than a bottom edge, an upper side, and an underside;
b. a strap system attached to the upper side of the flexible material and configured to form at least one carrying handle; and
c. a fastening system attached to the upper side of the flexible material and configured to secure the flexible material around a harvested wild turkey when the wild turkey is placed on the underside of the flexible material and the flexible material is folded around the wild turkey.

16. The hunting carrier according to claim 15, wherein the strap system comprises a single elongated strap member attached at three points to the upper side of the flexible material to form two carrying handles.

17. The hunting carrier according to claim 15, wherein the fastening system comprises a plurality of hook and loop fasteners.

18. The hunting carrier according to claim 17, wherein the plurality of hook and loop fasteners comprises three hook and loop fasteners positioned at different locations on the upper side of the flexible material.

19. The hunting carrier according to claim 15, wherein the flexible material is configured to completely enclose the harvested wild turkey when properly secured.

20. The hunting carrier according to claim 15, wherein the flexible material is foldable or rollable for compact storage when not in use.
